(19) United States
(12) Patent Application Publication
(10) Pub. No.: US 2012/0243016 A1
(43) Pub. Date: Sep. 27, 2012

(54) CONTROLLER, IMAGE FORMING APPARATUS, NON-TRANSITORY COMPUTER READABLE MEDIUM THAT STORES PROGRAM, AND CONTROL METHOD

(75) Inventor: Koji AMANO, Kanagawa (JP)

(73) Assignee: FUJI XEROX CO., LTD., Tokyo (JP)

(21) Appl. No.: 13/234,386

(22) Filed: Sep. 16, 2011

(30) Foreign Application Priority Data
Mar. 25, 2011 (JP) 2011-066871

(51) Int. Cl. G06K 15/02

(52) U.S. Cl. 358/1.13

(57) ABSTRACT

A controller includes: a history storage unit that stores a history of setup information when executing a function of an image forming apparatus; an acquisition unit that when a first function is selected on a menu screen having a first display region where a screen for selection of a function of the image forming apparatus is displayed, acquires the history of setup information when executing the first function from the history storage unit; a display control unit that lists the history of the setup information, which is acquired from the history storage unit, in a region other than the first display region on the menu screen; and an execution unit that executes the first function using setup information selected by a user from the history of the setup information listed.

### CROSS-REFERENCE TO RELATED APPLICATIONS

This application is based on and claims priority under 35 USC 119 from Japanese Patent Application No. 2011-066871 filed Mar. 25, 2011.

### BACKGROUND

(i) Technical Field

The present invention relates to a controller, an image forming apparatus, a non-transitory computer readable medium that stores a program, and a control method.

(ii) Related Art

In recent years, the number of setup information which is received from a user on the operation screen when executing a function of an image forming apparatus is increasing as the number of functions of the image forming apparatus increases.

### SUMMARY

According to an aspect of the invention, there is provided a controller including: a history storage unit that stores a history of setup information when executing a function of an image forming apparatus; an acquisition unit that when a first function is selected on a menu screen having a first display region where a screen for selection of a function of the image forming apparatus is displayed, acquires the history of setup information when executing the first function from the history storage unit; a display control unit that lists the history of the setup information, which is acquired from the history storage unit, in a region other than the first display region on the menu screen; and an execution unit that executes the first function using setup information selected by a user from the history of the setup information listed.

### BRIEF DESCRIPTION OF THE DRAWINGS

Exemplary embodiments of the present invention will be described in detail based on the following figures, wherein:

FIG. 1 is a block diagram showing an example of the configuration of an image forming apparatus according to an exemplary embodiment;

FIG. 2 is a view showing an example of the configuration of an operation and display unit;

FIG. 3 is a block diagram showing an example of the hardware configuration of the controller;

FIG. 4 is a functional block diagram showing an example of a function of the controller;

FIG. 5 is a view showing an example of history information stored in a history storage unit;

FIG. 6 is a flow chart showing an example of processing executed by the controller;

FIG. 7 is a flow chart showing an example of processing executed by the controller;

FIG. 8 is a flow chart showing an example of processing executed by the controller;

FIG. 9A is a view showing an example of a menu screen displayed on a display, and FIG. 9B is a view showing an example of an icon disposed on a button of each function; and

FIGS. 10A to 10C are views showing examples of an operation screen displayed on a display.

### DETAILED DESCRIPTION

Hereinafter, exemplary embodiments of the invention will be described with reference to the accompanying drawings.

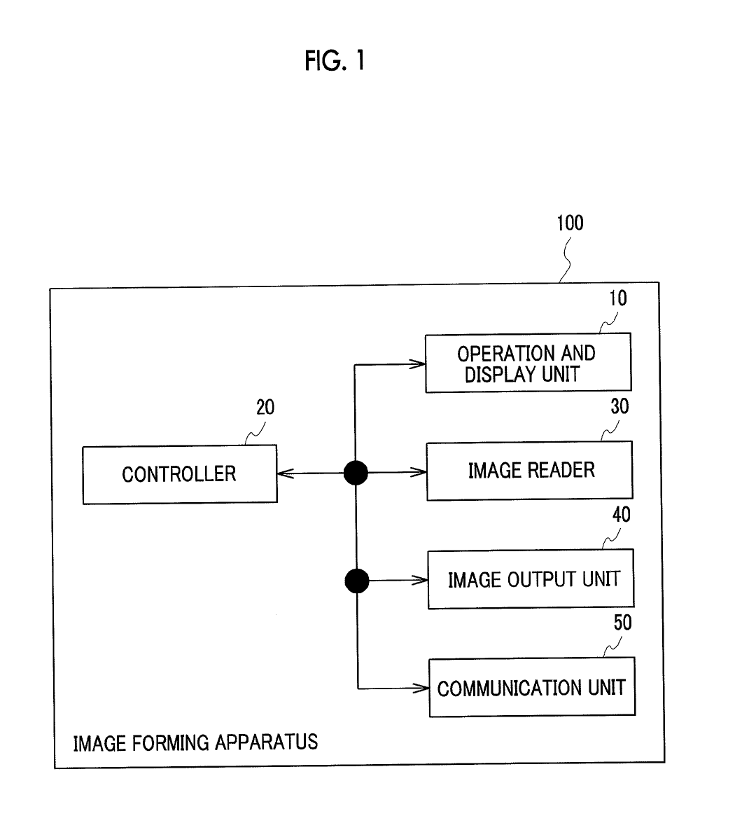

FIG. 1 is a view showing an example of the configuration of an image forming apparatus 100 according to an exemplary embodiment. The image forming apparatus 100 includes an operation and display unit 10, a controller 20, an image reader 30, an image output unit 40, and a communication unit 50.

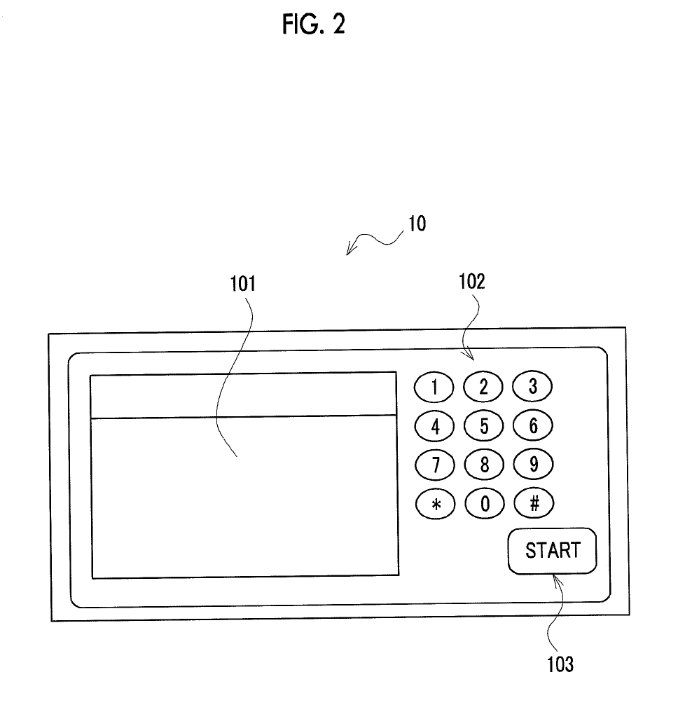

The operation and display unit 10 receives an instruction to the image forming apparatus 100 from a user. FIG. 2 shows an example of the configuration of the operation and display unit 10. The operation and display unit 10 includes a display 101, a ten key 102, and a start button 103. An operation screen (menu screen or the like) for receiving an operation on the image forming apparatus 100 from a user is displayed on the display 101. The ten key 102 is used to input the number of copies when a user executes copy or to input a telephone number of a transmission destination when a user sends a FAX. The start button 103 is a button for starting the execution of a function selected on a menu screen displayed on the display 101 by the user.

The operation and display unit 10 displays an operation screen, which is for receiving the operation input to the image forming apparatus 100 from the user, on the display 101 under control of the controller 20. The operation and display unit 10 receives an instruction to the image forming apparatus 100 from the user through the operation screen. The operation and display unit 10 outputs to the controller 20 an instruction to the image forming apparatus 100 received from the user through the operation screen, the ten key 102, and the start button 103 displayed on the display 101.

The controller 20 controls the overall operation of the image forming apparatus 100. Specifically, the controller 20 controls the operation and display unit 10 to display an operation screen on the display 101. In addition, the controller 20 receives an instruction to the image forming apparatus 100 from the operation and display unit 10.

In addition, the controller 20 controls the image reader 30, the image output unit 40, and the communication unit 50 provided in the image forming apparatus 100 on the basis of the received instruction. For example, when an instruction to read (scan) an image is received from the operation and display unit 10, the controller 20 controls the image reader 30 to read a document placed on the document platen and acquires a document image. In addition, when a copy instruction is received from the operation and display unit 10, the controller 20 controls the image reader 30 to read a document placed on the document platen and acquires a document image. Then, the controller 20 controls the image output unit 40 to form the acquired document image on a recording medium, such as paper, and outputs it.

In addition, when a scan (PC saving) instruction is received from the operation and display unit 10, the controller 20 controls the image reader 30 to read a document placed on the document platen and acquires a document image. Then, the controller 20 controls the communication unit 50 to store the acquired document image in an information processing apparatus (not shown). In addition, when a FAX transmission instruction is received from the operation and display unit 10, the controller 20 controls the image reader 30 first to read a document to be transmitted, which is placed on the document platen, and acquires a document image. Then, the controller 20 controls the communication unit 50 to transmit the acquired document image to the destination designated by the operation and display unit 10.

The image reader 30 is a scanner, for example. The image reader 30 reads a document placed on the document platen under control of the controller 20 and outputs the read document image to the controller 20.

The image output unit 40 forms an image on a recording medium, such as paper, under control of the controller 20 and outputs it.

The communication unit 50 transmits a document image or the like, which is to be transmitted, to the destination designated by the user through the operation and display unit 10 under control of the controller 20.

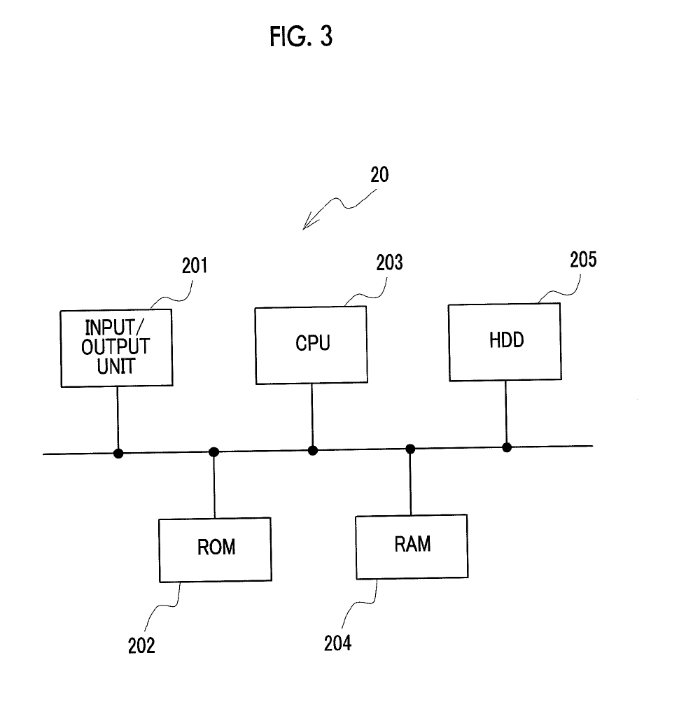

Next, the hardware configuration of the controller 20 will be described. FIG. 3 is a block diagram showing the hardware configuration of the controller 20.

The controller 20 includes an input/output unit 201, a ROM (Read Only Memory) 202, a CPU 203, a RAM (Random Access Memory) 204, and an HDD (Hard Disk Drive) 205.

The input/output unit 201 transmits or receives data to or from the operation and display unit 10, the image reader 30, the image output unit 40, and the communication unit 50. The ROM 202 stores a program (will be described in detail later) for listing the history of setup information, which is relevant to a function of an object to be executed, on a menu screen. The CPU 203 reads and executes a program stored in the ROM 202. The RAM 204 stores temporary data used when executing a program. The HDD 205 stores the history of the setup information when each function of the image forming apparatus 100 is executed, for example.

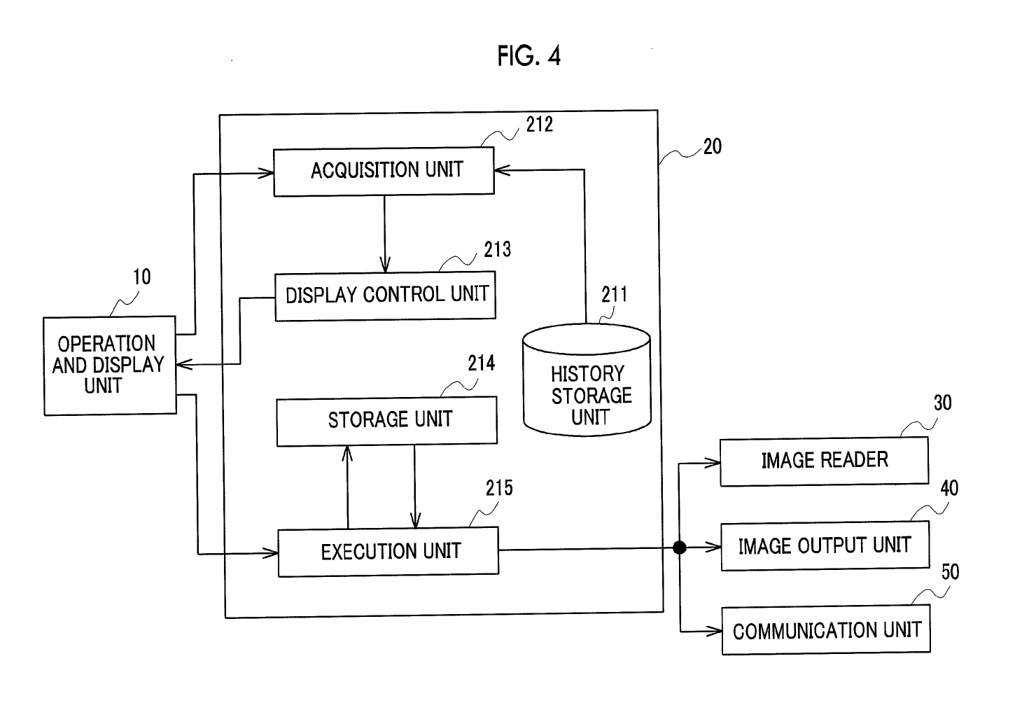

Next, an example of a function of the controller 20 will be described. FIG. 4 is a functional block diagram showing an example of a function of the controller 20. The controller 20 includes a history storage unit 211, an acquisition unit 212, a display control unit 213, a storage unit 214, and an execution unit 215. The history storage unit 211 is the HDD 205, for example. The storage unit 214 is the RAM 204 or the HDD 205, for example. In addition, the acquisition unit 212, the display control unit 213, and the execution unit 215 are realized by operations of a program which is stored in the ROM 202 and executed by the CPU 203.

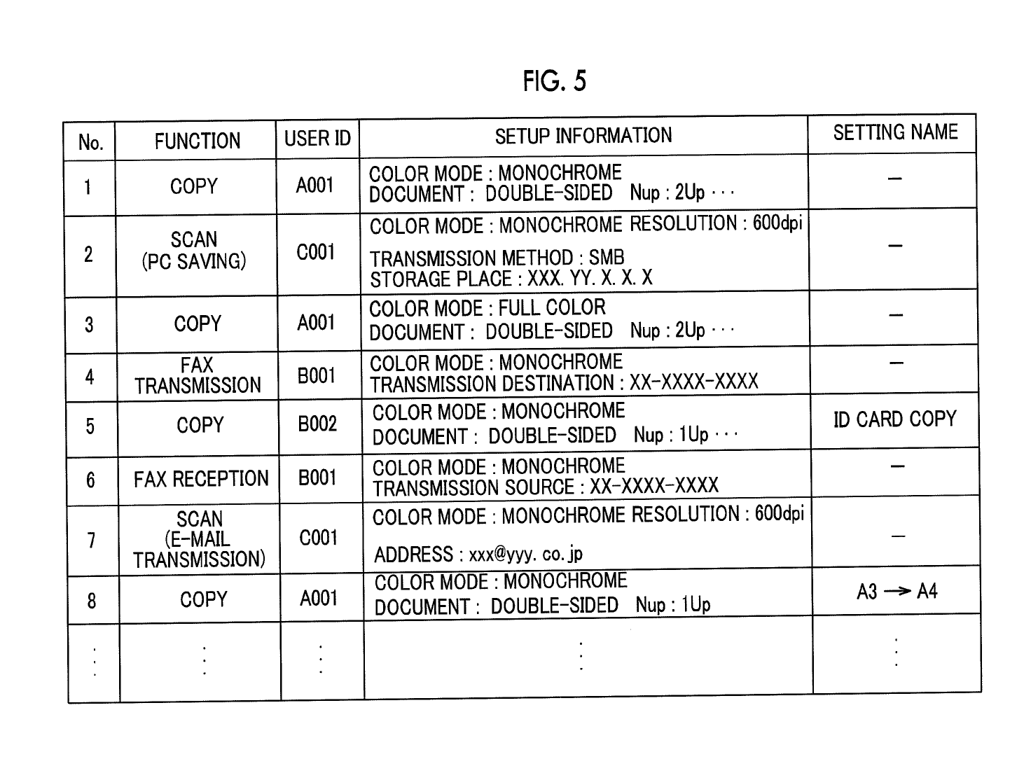

When executing a function of the image forming apparatus 100, the history storage unit 211 records the setup information, which is set for setting items of the function, so as to be associated with the function. That is, the history storage unit 211 stores history (history information) of the setup information when executing the function. Here, an example of the history information stored in the history storage unit 211 will be described with reference to FIG. 5.

FIG. 5 is a view showing an example of the history information stored in the history storage unit 211. In the present exemplary embodiment, the history information includes “No.”, “function”, “user ID”, “setup information”, and “setting name” as items.

A number automatically assigned to processing executed in the image forming apparatus 100 is stored in the item “No”. A function executed in the processing identified by “No.” is stored in the item “function”. ID information for uniquely identifying a user who executes the processing identified by “No.” is stored in the item “user ID”.

In the “setup information”, setup information such as printing conditions or operating conditions set for the image forming apparatus 100 when the “function” is executed is stored. In addition, information stored in the “setup information” depends on the “function”. For example, when the “function” is “copy”, setup information when copy is executed is stored in the “setup information”. Specifically, setup information, such as “color mode” setting, “document” setting, and “Nup” setting, is stored. The “color mode” setting is a setting for selecting color copy or monochrome copy. The “document” setting is a setting for selecting single-sided printing for printing only on the surface of paper or double-sided printing for printing on the front and back surfaces of paper. The “Nup” setting is a setting for printing plural pages (N pages) on a sheet of paper side by side.

Moreover, for example, when the “function” is “scan (PC saving)”, setup information when scanning is executed and a scan image is stored in a PC is stored in the “setup information”. Specifically, setup information, such as “color mode” setting which is for setting whether to read a document in color or in monochrome and “resolution” setting which is for setting the resolution when reading a document, is stored. In addition, a “transmission method” when transmitting a read document image to an information processing apparatus, a “storage place” for identifying an information processing apparatus at the storage place, and the like are stored as setup information. In addition, when the “function” is “scan (e-mail transmission)”, setup information, such as “color mode” setting which is for setting whether to read a document in color or in monochrome and “resolution” setting which is for setting the resolution when reading a document, is stored. In addition, an “address” to which the read document image is transmitted is stored as setup information.

In addition, for example, when the “function” is “FAX transmission”, setup information at the time of FAX transmission is stored in the “setup information”. Specifically, “color mode” setting which is for setting whether to send a FAX in color or in monochrome and a “transmission destination” indicating the transmission destination of the FAX are stored as setup information. In addition, when the “function” is “FAX reception”, setup information at the time of FAX reception is stored in the “setup information”. Specifically, “color mode” setting which is for setting whether to receive a FAX in color or in monochrome and a “transmission source” indicating the transmission source of the received FAX are stored as setup information.

A name given by the user in order to uniquely identify a setting stored in the “setup information” is stored in the “setting name”. For example, a name by which the “setup information” can be easily guessed is set in the “setting name”. For example, in processing of No. 4, a setting name of “ID card copy” is given to the setup information set when executing a copy function. For example, a user gives a setting name of “ID card copy” for a setting which is used when copying an ID card. In addition, in processing of No. 8, a setting name of “A3->A4” is given to the setup information set when executing a copy function. For example, a user gives a setting name “A3->A4” for a setting for copying an A3 sized document on A4 paper. In addition, data does not need to be input in the “setting name”. In FIG. 5, “−” means that a “setting name” is not input.

In FIG. 5, for example, in the processing of No. 1, a copy function is executed by a user with a user ID “A001”. In addition, the copy executed in the processing of No. 1 is a monochrome double-sided copy. Accordingly, 2 pages are printed on one sheet of paper.

In addition, for example, in the processing of No. 2, a scan (PC saving) function is executed by a user with a user ID “C001”. Moreover, in the processing of No. 2, a document image read in monochrome with the resolution of 600 [dpi] is stored in an information processing apparatus represented by the IP address “XXX. YY. X. X. X” using an SMB (Server Message Block) transfer protocol.

In addition, for example, in the processing of No. 4, a FAX transmission function is executed by a user with a user ID “B001”. In addition, a monochrome image is transmitted to the transmission destination represented by a telephone number “XX-XXXX-XXXX”.

As described above, the history storage unit 211 stores a function executed in the image forming apparatus 100 and the setup information when the function is executed, as history information, so as to be associated with each other.

Referring back to FIG. 4, the explanation will continue. The acquisition unit 212 acquires a function selected by the user on the menu screen displayed on the operation and display unit 10. In addition, the menu screen is a screen for displaying plural functions of the image forming apparatus 100 and receiving the selection of a function to be executed from a user.

The acquisition unit 212 acquires from the history storage unit 211 history of the setup information when the function selected by the user is executed in the past. For example, it is assumed that a user with a user ID “A001” selects a “copy function” on the menu screen. In this case, the acquisition unit 212 acquires history information of Nos. 1, 3, and 8 in which “A001” is stored in the “user ID” and “copy” is stored in the “function”, in the history information shown in FIG. 5, from the history storage unit 211. The acquisition unit 212 outputs the acquired history information to the display control unit 213.

The display control unit 213 receives the history information from the acquisition unit 212. The display control unit 213 lists some or all of the setup information included in the history information on the menu screen displayed on the display 101. The user selects which setup information of the setup information displayed on the menu screen is to be used.

When plural functions are selected on the menu screen, the storage unit 214 receives a function selected by the user and the setup information of the function from the execution unit 215 and temporarily stores them.

The execution unit 215 receives from the operation and display unit 10 the function selected by the user on the menu screen and the setup information of the function. When only one function is selected on the menu screen and the start button 103 is pressed on the operation and display unit 10, the execution unit 215 controls the image reader 30, the image output unit 40, and the communication unit 50 to execute the selected function using the selected setup information. When plural functions are selected on the menu screen, the execution unit 215 stores the function selected by the user and the setup information temporarily in the storage unit 214. In addition, when the start button 103 is pressed on the operation and display unit 10, the function selected by the user and the setup information are acquired from the storage unit 214. Then, the execution unit 215 controls the image reader 30, the image output unit 40, and the communication unit 50 to execute the function acquired from the storage unit 214 on the basis of the acquired setup information.

Next, an example of processing executed by the controller 20 will be described using some examples of the menu screen.

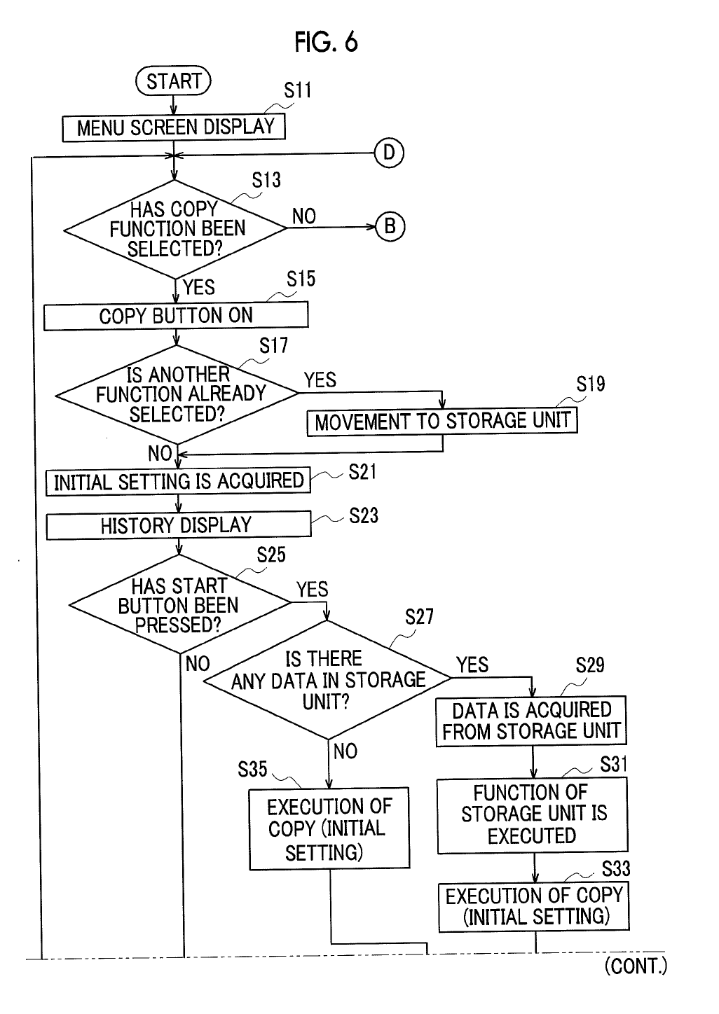

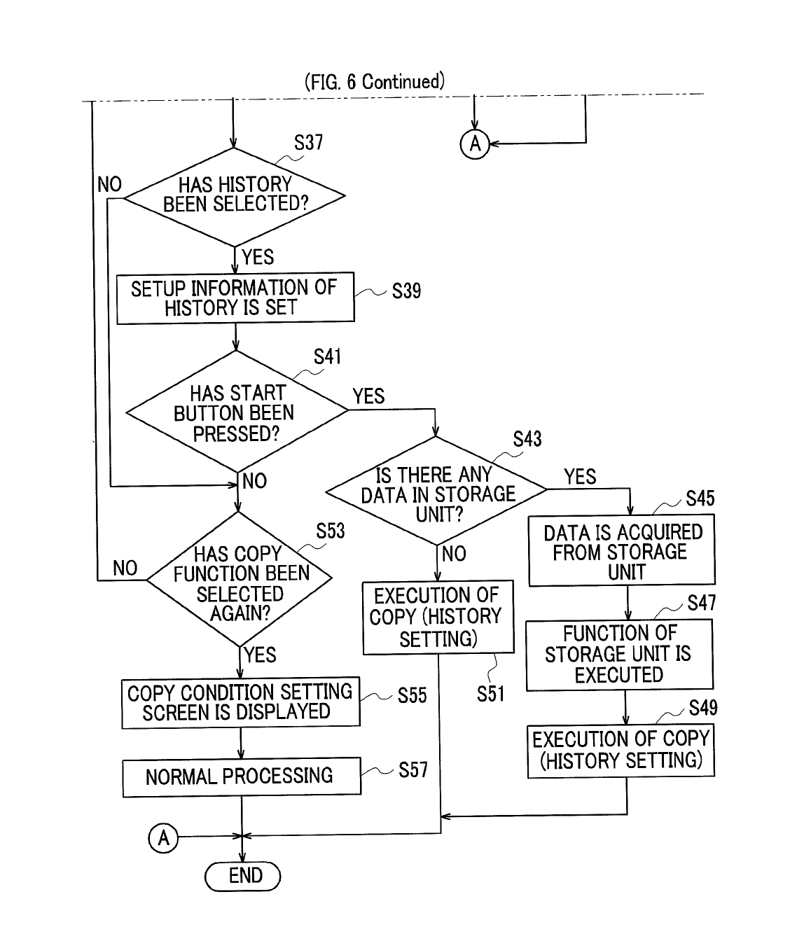

FIGS. 6 to 8 are flow charts showing an example of processing executed by the controller 20.

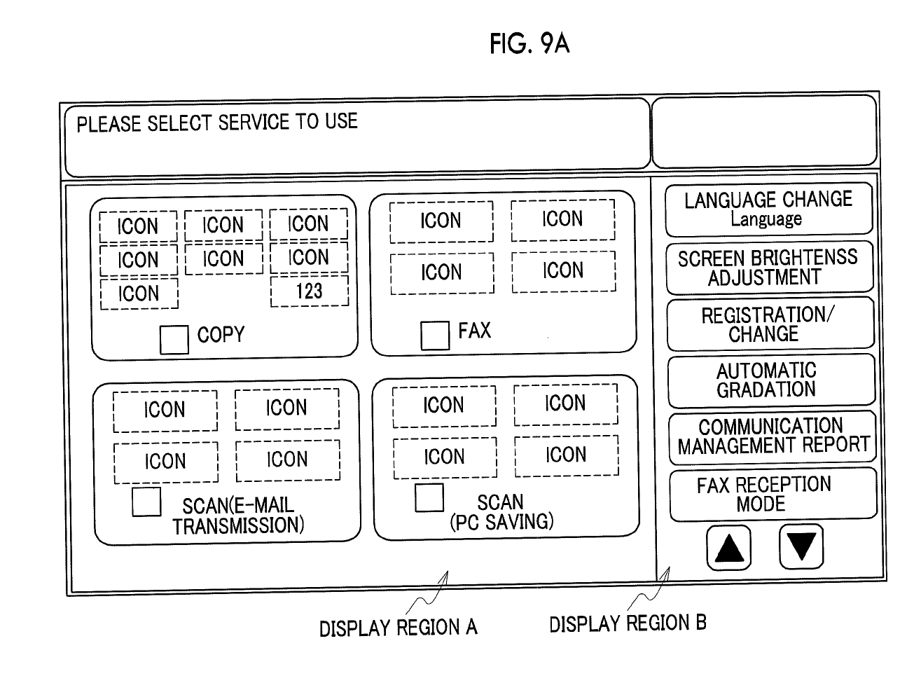

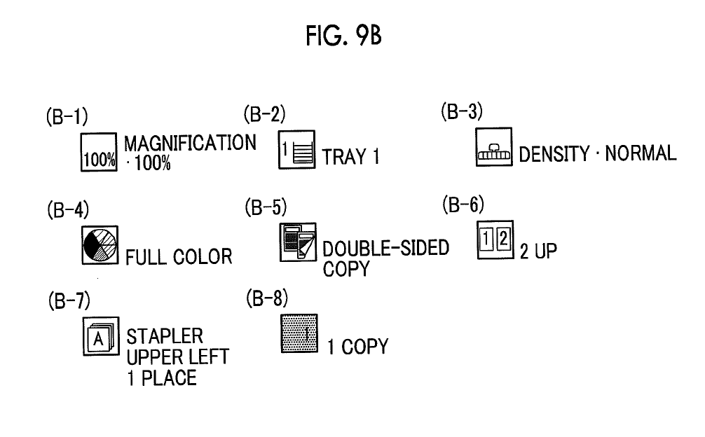

First, the display control unit 213 displays a menu screen shown in FIG. 9A on the display 101. FIG. 9A is a view showing an example of a menu screen displayed on the display 101. The menu screen shown in FIG. 9A has two display regions. In FIG. 9A, a button for selection of a function of the image forming apparatus 100 is disposed for each function in the display region A, and a button (utility button) regarding the setting of the image forming apparatus 100 is disposed in the display region B.

In the display region A, setup information of each function is displayed on a button for selection of each function using an icon (display as ICON in FIG. 9A). In a state where an operation of a user is not received, initial setup information of each function is displayed using an icon. When the user wants to execute each function without changing the initial setting, the user selects a function to execute and presses the start button 103. As a result, each function is executed using the initial setting. Next, FIG. 9B shows an example of an icon disposed on a button.

For example, an icon shown in FIG. 9B is disposed as the “ICON” in FIG. 9A. For example, (B-1) in FIG. 9B is an icon showing the setting regarding the reduction and enlargement of a document, and shows that the reduction/magnification ratio is 100% (the same magnification). (B-2) in FIG. 9B is an icon showing a tray on which paper is placed at the time of copy, and shows that paper is fed from a tray 1. (B-3) in FIG. 9B is an icon showing the print density at the time of copy and the reading density at the time of scanning, and shows that “normal” is set as the density. (B-4) in FIG. 9B is an icon showing “color mode” setting, and shows that full color is selected as “color mode”. (B-5) in FIG. 9B is an icon showing “document” setting, and shows that “double-sided copy” for copying on both sides of paper at the time of copy is set. (B-6) in FIG. 9B is an icon showing “Nup” setting, and shows that “2 up” for printing two pages on one sheet of paper side by side is selected. (B-7) in FIG. 9B is an icon showing the setting regarding “post-processing” after copy or printing ends, and shows a setting for stapling the upper left of paper after copy. (B-8) in FIG. 9B is an icon showing the number of copies or the number of sheets of paper to be printed, and shows that one copy is set as the number of copies. In addition, the number of copies may be changed with the ten key 102.

The setup information of each function is checked by the user by displaying the above icon on the button of each function.

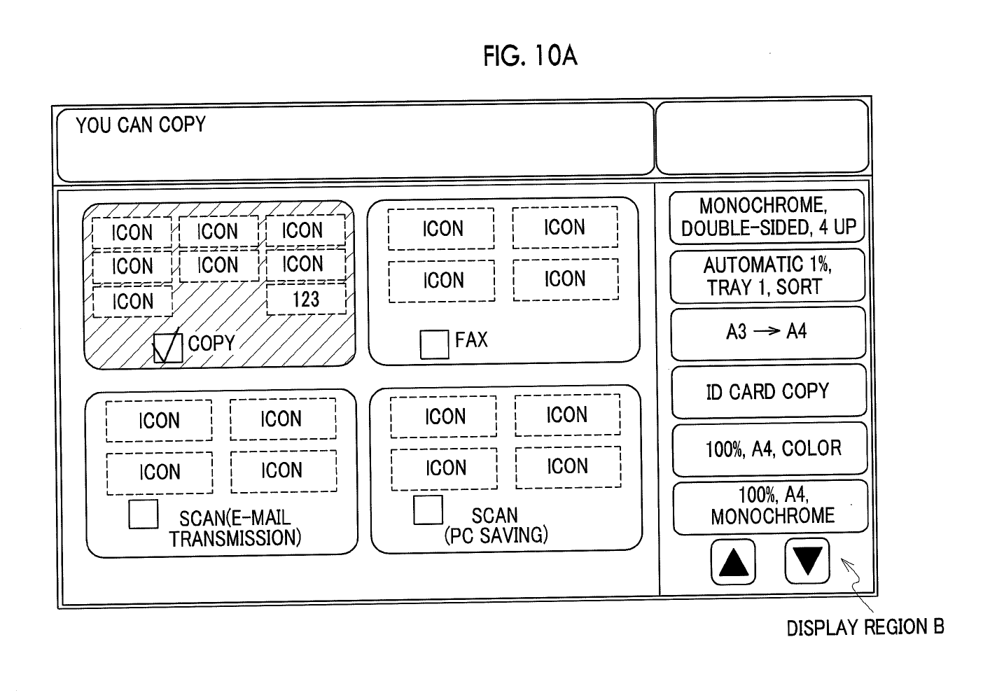

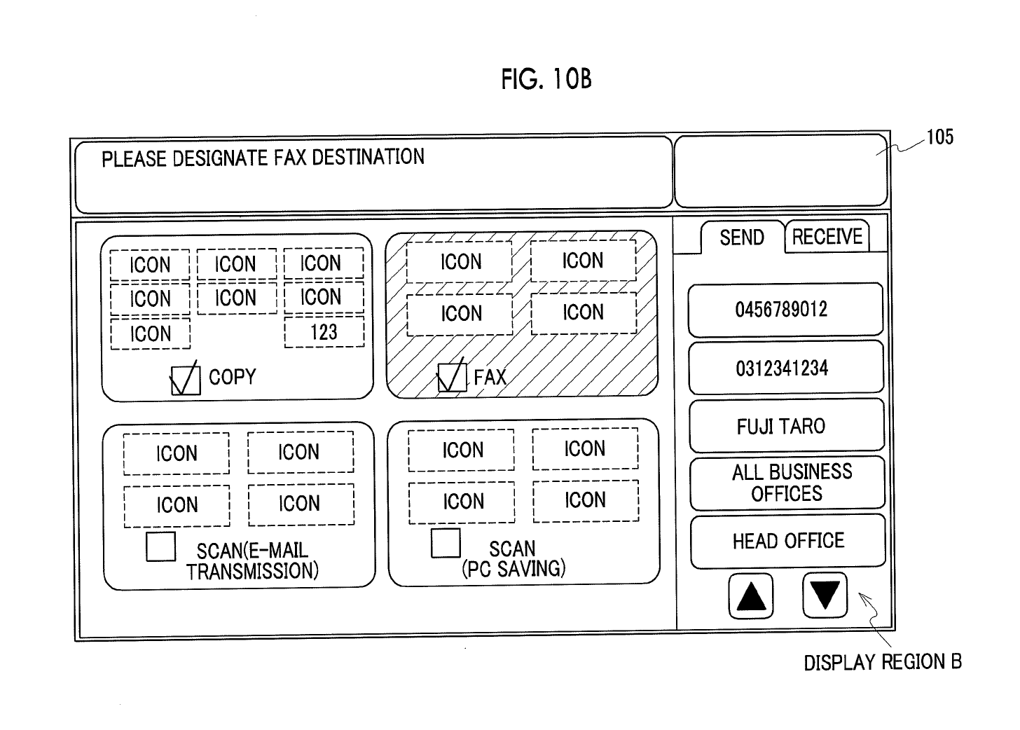

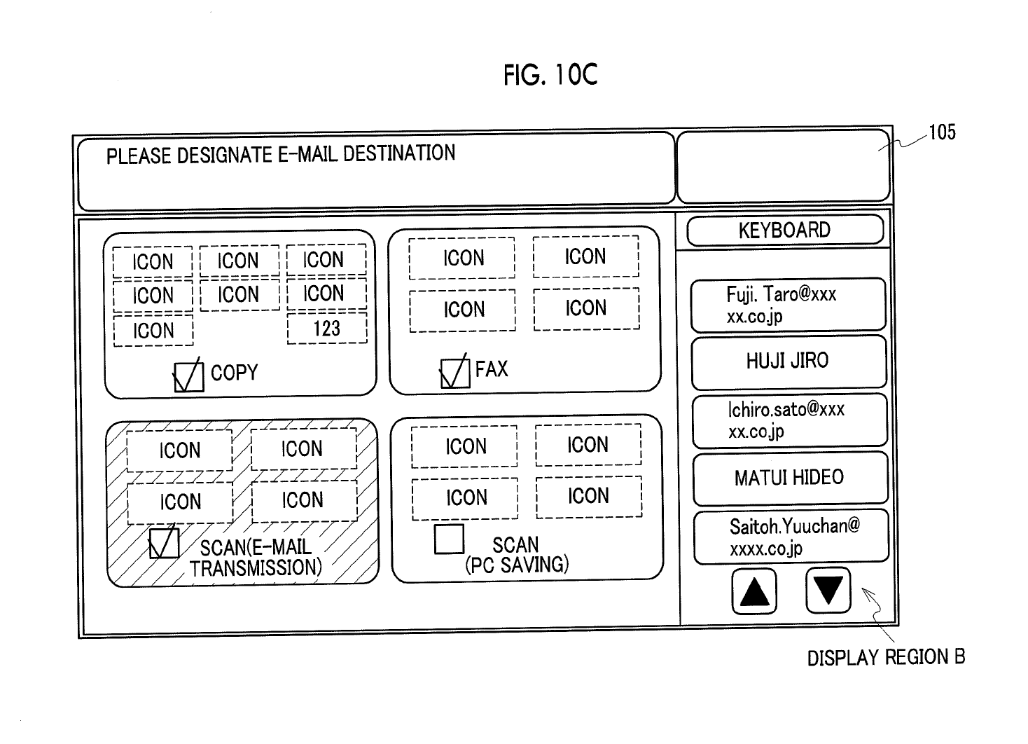

Referring back to FIG. 6, the explanation will continue. Then, the display control unit 213 determines whether or not a copy function has been selected by the user (step S13). When the copy function has been selected (step S13/YES), the display control unit 213 sets a copy button to ON on the menu screen (step S15). Specifically, as shown in FIG. 10A, a display format of a copy button is changed on the menu screen so that the user can identify that copy has been selected. In the example shown in FIG. 10A, the display control unit 213 displays a check mark on a check box of the copy function and also displays the copy function button in a different display format from other buttons (for example, displayed brightly or displayed dark).

Then, the execution unit 215 determines whether or not another function (for example, a scan function or a FAX function) is selected before the copy function is selected (step S17). Whether or not another function is selected may be determined on the basis of whether or not a check box of another function is checked, for example. In the example shown in FIG. 10A, it is determined that another function is not selected before the copy function is selected because check boxes of buttons other than the copy function button is not checked.

When another function is selected before the copy function is selected (step S17/YES), the execution unit 215 moves selected another function and the setup information, which is set for another function, to the storage unit 214 (step S19).

When another function is not selected before the copy function is selected (step S17/NO) or after step S19, the execution unit 215 acquires the initial setup information of the copy function (step S21).

Then, the acquisition unit 212 acquires the history information of the copy function from the history storage unit 211, and the display control unit 213 lists setup information included in the history information on the menu screen (step S23). Specifically, as shown in FIG. 9A, the display control unit 213 lists history of the setup information, which is set when copy is executed, in the display region B. In this case, the display control unit 213 may display all of the setup information included in the history or may display some of the setup information. Which setup information is to be displayed may be determined in advance for each user, or the manager of the image forming apparatus 100 may set it as initial setting. In addition, when a “setting name” is given to the setup information, the display control unit 213 may display the setting name. In the example shown in FIG. 10A, setting names of “A3->A4” and “ID card copy” are displayed instead of setup information.

Then, the execution unit 215 determines whether or not the start button 103 has been pressed (step S25). When the start button 103 has been pressed (step S25/YES), the execution unit 215 determines whether or not there is data in the storage unit 214 (step S27). Presence of data in the storage unit 214 means that another function is selected before the copy function is selected. Accordingly, when there is data in the storage unit 214 (step S27/YES), the execution unit 215 acquires the data from the storage unit 214 (step S29). Then, the execution unit 215 executes the function held in the storage unit 214 using the held setup information (step S31). Then, the execution unit 215 executes a copy operation after initial setting of copy (step S33), and this processing ends.

When there is no data in the storage unit 214 (step S27/NO), the execution unit 215 executes a copy operation after initial setting of copy (step S35), and this processing ends.

When the start button 103 has not been pressed (step S25/NO), the execution unit 215 determines whether or not any of the history has been selected by the user (step S37). When any of the history has been selected by the user (step S37/YES), the execution unit 215 sets the setup information included in the selected history as setup information when executing the copy function (step S39). In this case, the display control unit 213 may change an icon, which is disposed in the copy function button on the menu screen, according to the setup information.

Then, the execution unit 215 determines whether or not the start button 103 has been pressed (step S41). When the start button 103 has been pressed (step S41/YES), the execution unit 215 determines whether or not there is data in the storage unit 214 (step S43). When there is data in the storage unit 214 (step S43/YES), the execution unit 215 acquires the data from the storage unit 214 (step S45). Then, the execution unit 215 executes the function held in the storage unit 214 using the held setup information (step S47). Then, the execution unit 215 executes a copy operation using the setup information based on the history set in step S39 (step S49), and this processing ends.

When there is no data in the storage unit 214 (step S43/NO), the execution unit 215 executes a copy operation using the setup information based on the history set in step S39 (step S51), and this processing ends.

When no history has been selected by the user in step S37 (step S37/NO) or when the start button 103 has not been pressed in step S41 (step S41/NO), the display control unit 213 determines whether or not the copy function has been selected again (step S53).

When the copy function has not been selected again (step S53/NO), processing from step S13 is executed. When the copy function has been selected again (step S53/YES), the display control unit 213 displays a copy condition setting screen on the display 101 (step S55). Then, normal processing in which setting of the copy conditions is received from the user and the copy function is executed when the start button 103 is pressed is executed in the image forming apparatus 100 (step S57), and this processing ends.

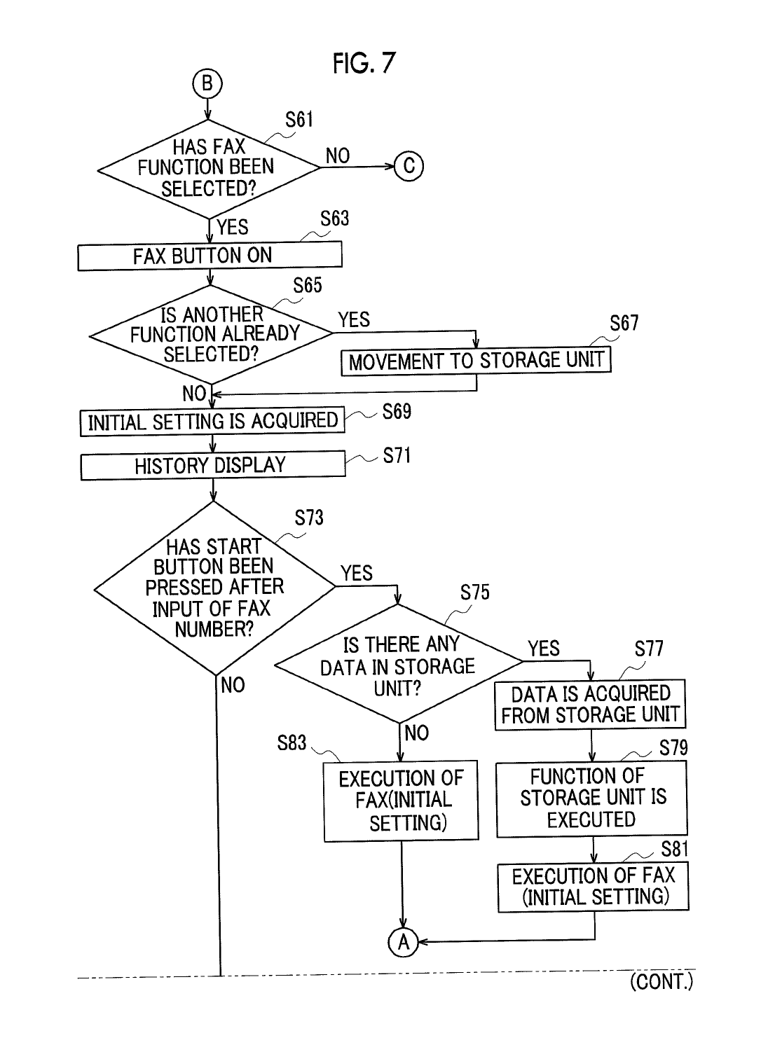

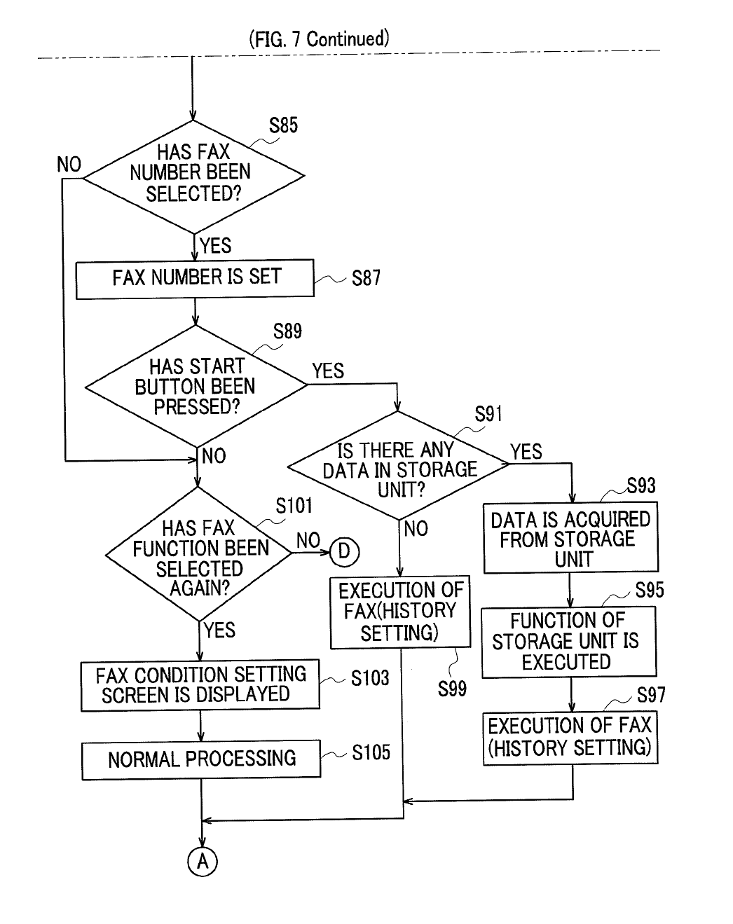

When the copy function has not been selected (step S13/NO), the display control unit 213 determines whether or not a FAX function has been selected (step S61 in FIG. 7). When the FAX function has been selected (step S61/YES), the display control unit 213 sets a FAX button to ON (step S63). Specifically, as shown in FIG. 10B, a display format of a FAX button is changed on the menu screen so that the user can identify that the FAX function has been selected.

Then, the execution unit 215 determines whether or not another function (for example, a copy function or a scan function) is selected before the FAX function is selected (step S65). When another function is selected before the FAX function is selected (step S65/YES), the execution unit 215 moves selected another function and the setup information, which is set for another function, to the storage unit 214 (step S67). In the example shown in FIG. 10B, a copy function is already selected before the FAX function is selected. Accordingly, the execution unit 215 moves the setup information of the copy function to the storage unit 214.

When another function is not selected before the FAX function is selected (step S65/NO) or after step S67, the execution unit 215 acquires the initial setup information of the FAX function (step S69). The initial setup information of the FAX function includes a color mode, density, the quality of transmitted image, and the image quality of a document.

Then, the acquisition unit 212 acquires history of the setup information when executing the FAX function from the history storage unit 211, and the display control unit 213 lists transmission destination and transmission source information included in the history on the menu screen (step S71). Specifically, as shown in FIG. 10B, the display control unit 213 displays history of the transmission destination set at the time of FAX transmission and the transmission source of the received FAX in the display region B. In FIG. 10B, history of the transmission destination at the time of FAX transmission is displayed if a tab of “transmission” is selected, and history of the transmission source of the received FAX is displayed if a tab of “reception” is selected.

Then, the execution unit 215 determines whether or not a FAX number has been input using the ten key 102 and the start button 103 has been pressed (step S73). When a FAX number has been input and the start button 103 has been pressed (step S73/YES), the execution unit 215 determines whether or not there is data in the storage unit 214 (step S75). Presence of data in the storage unit 214 means that another function is selected before the FAX function is selected. Accordingly, when there is data in the storage unit 214 (step S75/YES), the execution unit 215 acquires the data from the storage unit 214 (step S77). Then, the execution unit 215 executes the function held in the storage unit 214 using the held setup information (step S79). Then, the execution unit 215 sends a FAX to the FAX number input in step S73 using the initial setup information (step S81), and this processing ends.

When there is no data in the storage unit 214 (step S75/NO), the execution unit 215 sends a FAX to the FAX number input in step S73 using the initial setup information (step S83), and this processing ends.

When a FAX number has not been input using the ten key 102 and the start button 103 has not been pressed (step S73/NO) the execution unit 215 determines whether or not any of the transmission destination and the transmission source displayed as the history in step S71 has been selected by the user (step S85). When any of the transmission destination and the transmission source has been selected by the user (step S85/YES), the execution unit 215 sets the selected FAX number as a transmission destination at the time of FAX transmission (step S87). In this case, the display control unit 213 may display a destination name and a FAX number in an upper portion 105 on the menu screen.

Then, the execution unit 215 determines whether or not the start button 103 has been pressed (step S89). When the start button 103 has been pressed (step S89/YES), the execution unit 215 determines whether or not there is data in the storage unit 214 (step S91). When there is data in the storage unit 214 (step S91/YES), the execution unit 215 acquires the data from the storage unit 214 (step S93). Then, the execution unit 215 executes the function held in the storage unit 214 using the held setup information (step S95). Then, the execution unit 215 sends a FAX to the FAX number selected in step S87 (step S97), and this processing ends.

When there is no data in the storage unit 214 (step S91/NO), the execution unit 215 sends a FAX to the FAX number selected in step S87 (step S99), and this processing ends.

When none of the transmission destination and the transmission source has been selected by the user in step S85 (step S85/NO) or when the start button 103 has not been pressed in step S89 (step S89/NO), the display control unit 213 determines whether or not the FAX function has been selected again (step S101).

When the FAX function has not been selected again (step S101/NO), processing from step S13 in FIG. 6 is executed. When the FAX function has been selected again (step S101/YES), the display control unit 213 displays a FAX condition setting screen on the display 101 (step S103). Then, normal processing in which setting of the FAX conditions is received from the user and the FAX function is started when the start button 103 is pressed is executed in the image forming apparatus 100 (step S105), and this processing ends.

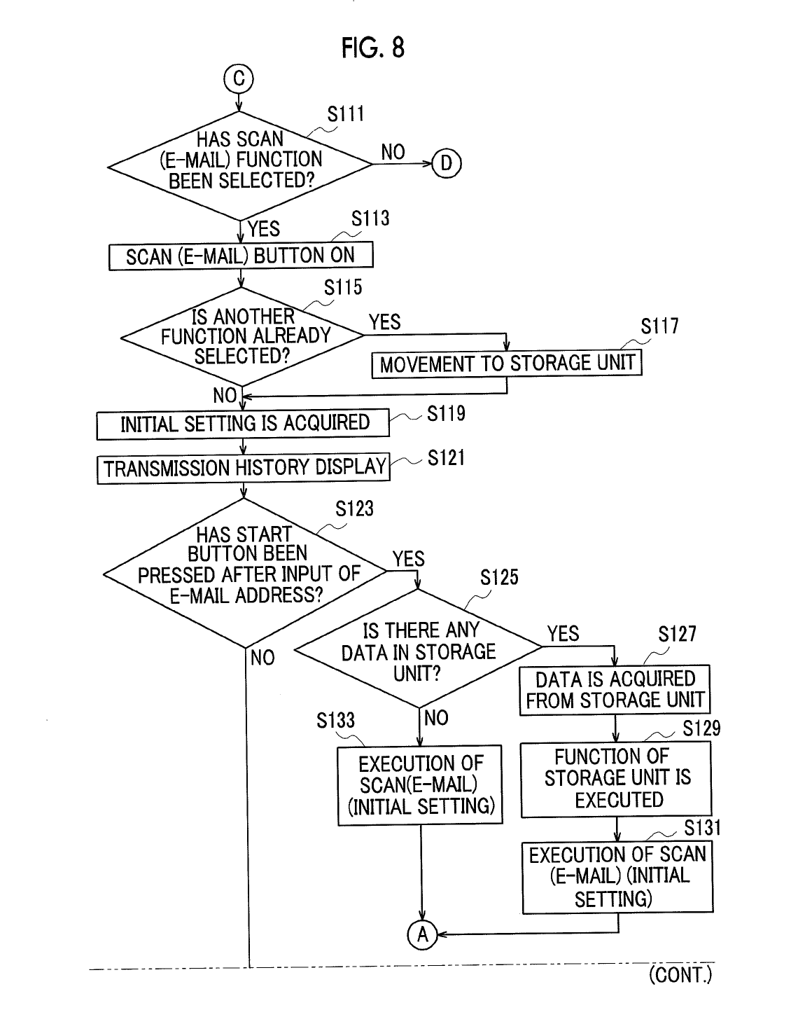

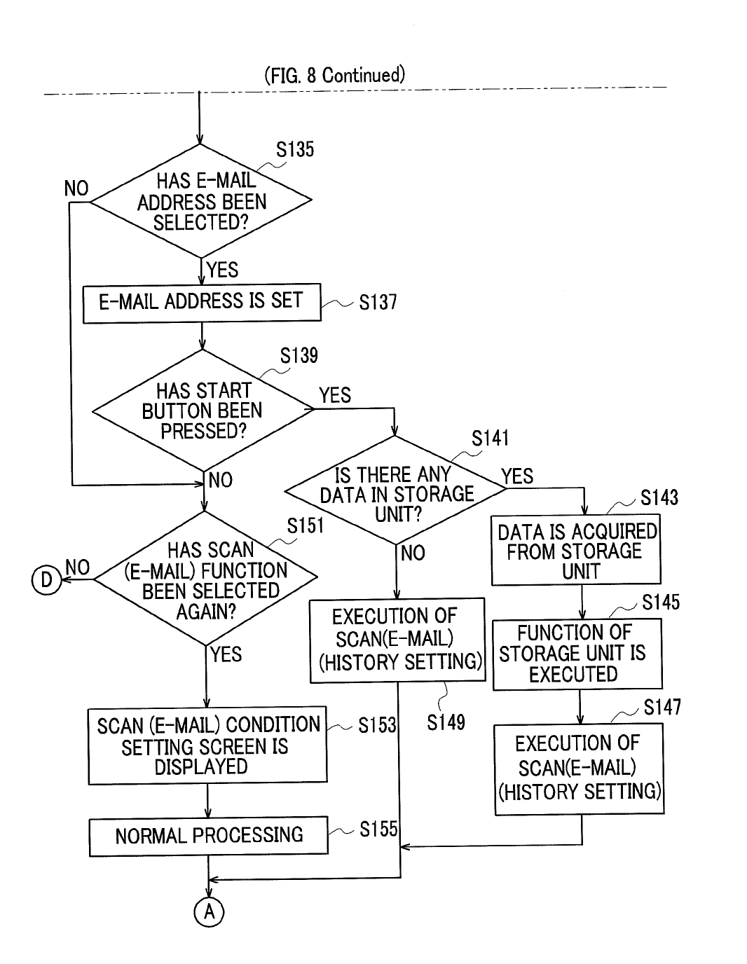

When the FAX function has not been selected (step S61/NO), the display control unit 213 determines whether or not a scan (e-mail transmission) function has been selected (step S111 in FIG. 8). In addition, the scan (e-mail transmission) function refers to a function of reading (scanning) a document placed on the document platen and transmitting the read document image to the designated destination by e-mail.

When the scan (e-mail transmission) function is selected (step S111/YES), the display control unit 213 sets a scan (e-mail transmission) button to ON (step S113). Specifically, as shown in FIG. 100, a display format of a scan (e-mail transmission) button is changed on the menu screen so that the user can identify that the scan (e-mail transmission) has been selected.

Then, the execution unit 215 determines whether or not another function (for example, a copy function or a FAX function) is selected before the scan (e-mail transmission) function is selected (step S115). When another function is selected before the scan (e-mail transmission) function is selected (step S115/YES), the execution unit 215 moves selected another function and the setup information, which is set for another function, to the storage unit 214 (step S117). In the example shown in FIG. 100, a copy function and a FAX function are already selected in this order before the scan (e-mail transmission) function is selected. Here, setup information of the copy function is already moved to the storage unit 214 when setting of the FAX function is performed. In this case, accordingly, the execution unit 215 moves the setup information of the FAX function to the storage unit 214.

When another function is not selected before the scan (e-mail transmission) function is selected (step S115/NO), the execution unit 215 acquires the initial setup information of the scan (e-mail transmission) function (step S119). The initial setup information of the scan (e-mail transmission) function includes a color mode, the image quality of a document, and the format of an output file.

Then, the acquisition unit 212 acquires history of the setup information when executing the scan (e-mail transmission) function from the history storage unit 211, and the display control unit 213 lists destination (e-mail address) included in the history on the menu screen (step S121). Specifically, as shown in FIG. 100, the display control unit 213 displays history, which is set at the time of e-mail transmission of the scanned document, in the display region B. Moreover, in FIG. 100, when a “keyboard” button has been selected, the display control unit 213 receives a manual input of an e-mail address from the user.

Then, the execution unit 215 determines whether or not the e-mail address has been manually input by the user and the start button 103 has been pressed (step S123). When the e-mail address has been manually input by the user and the start button 103 has been pressed (step S123/YES), the execution unit 215 determines whether or not there is data in the storage unit 214 (step S125). Presence of data in the storage unit 214 means that another function is selected before the scan (e-mail transmission) function is selected. Accordingly, when there is data in the storage unit 214 (step S125/YES), the execution unit 215 acquires the data from the storage unit 214 (step S127). Then, the execution unit 215 executes each function using the setup information stored in the storage unit 214 (step S129). For example, when the setup information regarding the copy function and the FAX function is stored in the storage unit 214, the execution unit 215 executes copy and FAX operations in this order using the setup information stored in the storage unit 214.

Then, the execution unit 215 transmits the scanned document to the e-mail address input in step S123 using the initial setup information (step S131), and this processing ends.

When there is no data in the storage unit 214 (step S125/NO), the execution unit 215 transmits the scanned document to the e-mail address input in step S123 using the initial setup information (step S133), and this processing ends.

When an e-mail address has not been input manually by the user and the start button 103 has not been pressed (step S123/NO), the execution unit 215 determines whether or not any e-mail address displayed as the history in step S121 has been selected by the user (step S135). When any e-mail address has been selected by the user (step S135/YES), the execution unit 215 sets the selected e-mail address as a destination at the time of e-mail transmission (step S137). In this case, the display control unit 213 may display a destination name and an e-mail address in the upper portion 105 on the menu screen.

Then, the execution unit 215 determines whether or not the start button 103 has been pressed (step S139). When the start button 103 has been pressed (step S139/YES), the execution unit 215 determines whether or not there is data in the storage unit 214 (step S141). When there is data in the storage unit 214 (step S141/YES), the execution unit 215 acquires the data from the storage unit 214 (step S143). Then, in the same manner as in the processing of step S129, the execution unit 215 executes each function using the setup information stored in the storage unit 214 (step S145). Then, the execution unit 215 sends the scanned document to the e-mail address selected in step S137 (step S147), and this processing ends.

When there is no data in the storage unit 214 (step S141/NO), the execution unit 215 sends the scanned document to the e-mail address set in step S137 (step S149), and this processing ends.

When no e-mail address displayed in the display region B has been selected by the user in step S135 (step S135/NO) or when the start button 103 has not been pressed in step S139 (step S139/NO), the display control unit 213 determines whether or not the scan (e-mail transmission) function has been selected again (step S151).

When the scan (e-mail transmission) function has not been selected again (step S151/NO), processing from step S13 in FIG. 6 is executed. When the scan (e-mail transmission) function has been selected again (step S151/YES), the display control unit 213 displays a scan (e-mail transmission) condition setting screen on the display 101 (step S153). Then, normal processing in which setting of the scan (e-mail transmission) conditions is received from the user and scanning and e-mail transmission are started when the start button 103 is pressed is executed in the image forming apparatus 100 (step S155), and this processing ends.

As is apparent from the above explanation, according to the exemplary embodiment, the history storage unit 211 stores history of the setup information when executing the function of the image forming apparatus 100, and the acquisition unit 212 acquires from the history storage unit 211 the history of the setup information when executing the function selected by the user on the menu screen. In addition, the display control unit 213 lists the history of the setup information acquired from the history storage unit 211 in the different display region B from the display region A, in which buttons for selection of each function are disposed, on the menu screen. The execution unit 215 executes a selected function using the setup information of history selected by the user from the history of the setup information displayed on the menu screen. According to this configuration, selection of a function and setting of the setup information for the selected function are performed by the user on the same menu screen. In addition, history of the setup information is listed in the display region B which is a different display region from the display region A where buttons for selection of each function are disposed. Accordingly, in the exemplary embodiment described above, it is not necessary to go back and forth between the function selection screen and the setup screen (operation history selection screen) in order to input the setup information, for example, unlike JP-A-2006-220940 and JP-A-2010-109865. That is, a series of operation related to the execution of a function from the selection of a function to the input of setup information is received from the user on the same menu screen.

In addition, when plural functions are selected on the display region A, the storage unit 214 stores each function and setup information set for each function. In addition, when another function is selected on the menu screen, the acquisition unit 212 acquires from the history storage unit 211 the setup information when executing the function, and the display control unit 213 lists history of the setup information when executing the acquired another function on the menu screen. The execution unit 215 executes the function stored in the storage unit 214 using the stored setup information and then executes another function using the setup information selected on the menu screen. Accordingly, even if plural functions are continuously executed, a series of operation related to the execution of a function from the selection of a function to the input of setup information is received from the user on the same menu screen. In addition, since each function is selected in the display region A and history of the setup information for each function is displayed in the display region B, it is not necessary to go back and forth between the function selection screen and the setup screen even if setting of plural functions are continuously performed.

Moreover, in the exemplary embodiment described above, the initial setup information of each function is displayed using an icon. Here, when listing history of the setup information, the display control unit 213 may list only history, which has different setup information from the initial setup information, on the menu screen. Therefore, the user can easily check the initial setup information. In addition, since the same history as the initial setup information is not listed, the number of items of history data listed is reduced. As a result, it becomes easy to select the setup information from the listed items of the history.

In addition, in the exemplary embodiment described above, the history storage unit 211 stores a setting name for identifying the setup information uniquely, and the display control unit 213 displays the setting name on the menu screen when listing the history. Since the content of the setup information is guessed by the “setting name”, it becomes easy to select the setup information from the listed items of the history.

In addition, in the exemplary embodiment described above, when a copy function is selected on the menu screen, the display control unit 213 displays history of the setup information used in processing executed using the copy function. Accordingly, when the user wants to rerun processing executed in the past, the user has only to select corresponding history. Thus, it becomes easy to execute the past processing again.

In addition, when a FAX function is selected on the menu screen, the display control unit 213 displays at least one of the destination of a FAX transmitted in the past and the transmission source of a FAX received in the past. By selecting a transmission destination from destinations of a FAX transmitted in the past, a FAX is transmitted to the destination of a FAX transmitted once. In addition, sending a reply to the transmission source of a FAX becomes easy by selecting a transmission destination from transmission sources of a FAX received in the past. In addition, a possibility of sending a FAX to the wrong destination is suppressed by displaying only the transmission destination/transmission source successful in transmission or reception of a FAX.

In addition, when a scan function is selected on the menu screen, the display control unit 213 displays a storage place where a read document is stored or a destination of the read document transmitted. Accordingly, it becomes easy to store the read document again or to transmit the read document again.

The exemplary embodiment described above is a part of exemplary embodiments of the invention. The exemplary embodiment of the invention is not limited to the above-described exemplary embodiment, and various modifications and changes may be made within the scope and spirit of the invention.

In addition, although the display order of history displayed in the display region B is not particularly limited in the exemplary embodiment described above, the display control unit 213 may determine the display order of history of setup information on the basis of at least one of date and time when the history information is stored in the history storage unit 211 and the number of times by which the same setup information is set. In this case, the history storage unit 211 stores the information regarding the date and time when each function is executed. In this case, for example, since setup information used in processing executed recently or setup information used many times is displayed sequentially from the top, it becomes easy to select the setup information. In addition, the method of determining the display order is not limited to the above method.

In addition, although the image forming apparatus 100 according to the exemplary embodiment described above performs management using a user ID, the invention may also be applied to the image forming apparatus 100 which does not perform management using a user ID. In this case, the history storage unit 211 does not store user ID information but outputs to the display control unit 213 the history information in which a function selected on the menu screen is stored in the “function” item.

In addition, although the display regions A and B are disposed so as to divide the menu screen in a vertical direction in the exemplary embodiment described above, the display regions A and B may also be disposed so as to divide the menu screen in a horizontal direction. The arrangement of the display regions A and B on the menu screen is not limited to the exemplary embodiment described above.

In addition, the function of the controller 20 may be realized by computer including a CPU, a ROM, a RAM, and the like. In that case, a program which describes details of processing of a function that the controller 20 should have is provided. The processing function is realized on the computer by causing the computer to execute the program. The program which describes details of the processing may be recorded on a computer-readable recording medium.

When a program is distributed, it is sold in the form of portable recording media in which the program is recorded, such as a DVD (Digital Versatile Disc) and a CD-ROM (Compact Disc Read Only Memory), for example. In addition, it is also possible to store a program in a storage device of a server computer and to transmit the program from the server computer to another computer through a network.

A computer which executes a program stores in its own storage device, for example, a program recorded in a portable recording medium or a program transmitted from the server computer. Then, the computer reads the program from its own storage device and executes processing according to the program. In addition, the computer may read the program directly from the portable recording medium and execute processing according to the program. In addition, whenever a program is transmitted from the server computer, the computer may execute the processing according to the received program in a sequential manner.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A controller comprising:
a history storage unit that stores a history of setup information when executing a function of an image forming apparatus;
an acquisition unit that when a first function is selected on a menu screen having a first display region where a screen for selection of a function of the image forming apparatus is displayed, acquires the history of setup information when executing the first function from the history storage unit;
a display control unit that lists the history of the setup information, which is acquired from the history storage unit, in a region other than the first display region on the menu screen; and
an execution unit that executes the first function using setup information selected by a user from the history of the setup information listed.

2. The controller according to claim 1, further comprising:
a storage unit that stores the first function selected on the menu screen and setup information set for the first function,
wherein when a second function is selected subsequent to the first function on the menu screen, the acquisition unit acquires history of setup information when executing the second function from the history storage unit, the display control unit lists the history of setup information when executing the acquired second function in a region other than the first display region, and
the execution unit executes the first function using setup information stored in the storage unit and then executes the second function using setup information selected for the second function from the history of the setup information listed.

3. The controller according to claim 1,
wherein initial setup information is displayed on the menu screen for each function of the image forming apparatus, and
the display control unit displays the history having different setup information from the initial setup information in a region other than the first display region.

4. The controller according to claim 2,
wherein initial setup information is displayed on the menu screen for each function of the image forming apparatus, and
the display control unit displays the history having different setup information from the initial setup information in a region other than the first display region.

5. The controller according to claim 1,
wherein the history storage unit stores a setting name for uniquely identifying setup information of each history, and
the display control unit displays the setting name when displaying the history of the setup information.

6. The controller according to claim 2,
wherein the history storage unit stores a setting name for uniquely identifying setup information of each history, and
the display control unit displays the setting name when displaying the history of the setup information.

7. The controller according to claim 3,
wherein the history storage unit stores a setting name for uniquely identifying setup information of each history, and
the display control unit displays the setting name when displaying the history of the setup information.

8. The controller according to claim 4,
wherein the history storage unit stores a setting name for uniquely identifying setup information of each history, and
the display control unit displays the setting name when displaying the history of the setup information.

9. The controller according to claim 1,
wherein the display control unit determines a display order of the history of the setup information on the basis of at least one of date and time stored in the history storage unit and the number of times by which the same setup information is set.

10. The controller according to claim 1,
wherein when the first function is a copy function, the display control unit displays the history of setup information used in processing executed using a copy function.

11. The controller according to claim 1,
wherein when the first function is a FAX function, the display control unit displays at least one of a destination of a FAX transmitted in the past and a transmission source of a FAX received in the past.

12. The controller according to claim 1,
wherein when the first function is a scan function, the display control unit displays a storage place where a read document is stored or a destination of the read document transmitted.

13. An image forming apparatus comprising:
a display that displays a menu screen having a first display region where a screen for selection of a function of the image forming apparatus is displayed;
a history storage unit that stores a history of setup information when executing the function;
an acquisition unit that when a first function is selected on the menu screen, acquires the history of setup information when executing the first function from the history storage unit;
a display control unit that lists the history of the setup information, which is acquired from the history storage unit, in a region other than the first display region on the menu screen; and
an execution unit that executes the first function using setup information selected by a user from the history of the setup information listed.

14. A non-transitory computer readable medium that stores a program causing a computer to execute a process, the process comprising:
storing a history of setup information when executing a function of an image forming apparatus in a storage device;
when a first function is selected on a menu screen having a first display region where a screen for selection of a function of the image forming apparatus is displayed, acquiring the history of setup information when executing the first function from the storage device;
listing the history of the setup information, which is acquired from the storage device, in a region other than the first display region on the menu screen; and
executing the first function using setup information selected by a user from the history of the setup information listed.

15. A control method comprising:
storing a history of setup information when executing a function of an image forming apparatus in a storage device;
when a first function is selected on a menu screen having a first display region where a screen for selection of a function of the image forming apparatus is displayed, acquiring the history of setup information when executing the first function from the storage device;
listing the history of the setup information, which is acquired from the storage device, in a region other than the first display region on the menu screen; and
executing the first function using setup information selected by a user from the history of the setup information listed.
